(19) United States
(12) Patent Application Publication
(10) Pub. No.: US 2015/0124286 A1
(43) Pub. Date: May 7, 2015

(54) CRUM UNIT MOUNTABLE IN CONSUMABLE UNIT OF IMAGE FORMING APPARATUS AND IMAGE FORMING APPARATUS USING THE SAME

(71) Applicant: SAMSUNG ELECTRONICS CO., LTD., Suwon-si (KR)

(72) Inventor: Youn-jae KIM, Yongin-si (KR)

(73) Assignee: SAMSUNG ELECTRONICS CO., LTD., Suwon-si (KR)

(21) Appl. No.: 14/338,777

(22) Filed: Jul. 23, 2014

(30) Foreign Application Priority Data
Nov. 1, 2013 (KR) 10-2013-0132562
Feb. 12, 2014 (KR) 10-2014-0016216

(51) Int. Cl. H04N 1/00

(52) U.S. Cl. CPC H04N 1/00034; H04N 1/00015
USPC 358/1.15

(57) ABSTRACT

A Customer Replacement Unit Monitor (CRUM) unit which is mountable on an image forming apparatus is provided. The CRUM unit includes a plurality of interfaces configured to be connected to the consumable unit and a power extracting circuit configured to, when a clock signal is received through one of the plurality of interfaces, extracts power from the clock signal, and the clock signal is a signal where a high value and a low value repeatedly alternate even in an idle section where a data signal is not received. Accordingly, the CRUM unit may operate even in the idle section by extracting power from the high value.

### CROSS-REFERENCE TO RELATED APPLICATIONS

This application claims priority from Korean Patent Application No. 10-2013-0132562, filed in the Korean Intellectual Property Office on Nov. 1, 2013 and Korean Patent Application No. 10-2014-0016216, filed in the Korean Intellectual Property Office on Feb. 12, 2014, the disclosure of which is incorporated herein by reference.

### BACKGROUND OF THE INVENTION

1. Field of the Invention

Aspects of the exemplary embodiments relate to a Customer Replacement Unit Monitor (CRUM) unit mountable in a consumable unit of an image forming apparatus and an image forming apparatus using the same, and more particularly, to a CRUM unit which extracts power from a clock signal and an image forming apparatus using the same.

2. Description of the Related Art

With the development of electronic technology, various types of electronic products have been developed. In particular, as computers are used widely, the distribution rate of computer peripheral devices has also been increasing. The computer peripheral devices refer to devices which improve usability of computers, and include such image forming apparatuses as a printer, a scanner, a copier, an MFP, etc.

The image forming apparatuses use an ink or a toner to print an image on a paper. An ink or a toner is used every time an image forming job is performed and used up if it is used for more than a predetermined time. In this case, a unit which stores the ink or the toner should be replaced. As such, a part or an element which is replaced in the process of using an image forming apparatus is referred to as a consumable unit or a replaceable unit. For convenience of explanation, it will be referred to as a consumable unit in this specification.

The consumable unit includes not only a unit which should be replaced when it is used up, such as an ink or a toner, but also a unit which should be replaced after a predetermined period of time since its properties change as time goes by and thus, high printing quality cannot be expected. That is, the consumable unit may also include such parts as a color developer and an intermediate transfer belt. Such consumable units should be replaced regularly at an appropriate replacement time.

The replacement time may be determined using a use condition index. The user condition index represents the degree of use of an image forming apparatus, and may be the number of papers which are printed and output from an image forming apparatus, the number of dots forming an image, etc. An image forming apparatus may count the number of papers or dots to determine the replacement time of each consumable unit.

Recently, in order to allow a user to determine the replacement time of each unit accurately, a CRUM unit is mounted in each consumable unit.

If a consumable unit is mounted on an image forming apparatus, a CRUM unit and the image forming apparatus are able to communicate with each other through the consumable unit. The consumable unit includes a power terminal to receive power provided from the image forming apparatus. Accordingly, the power provided from the image forming apparatus is transmitted to the power terminal, and the CRUM unit may operate by receiving the power from the power terminal.

However, considering the structural feature, the power terminal to provide power may increase the number of terminals of the consumable unit or the number of interfaces of the CRUM unit. The increasing number of terminals or interfaces also increase the size of the consumable unit or the CRUM unit, influencing the costs of the consumable unit or the CRUM unit.

In addition, as the power is supplied even to an idle section where data is not received through the power terminal, the power consumption of the image forming apparatus is increasing.

It is an object of the present invention to address the abovementioned disadvantages.

### SUMMARY OF THE INVENTION

According to the present invention there is provided an apparatus and method as set forth in the appended claims. Other features of the invention will be apparent from the dependent claims, and the description which follows.

An aspect of the exemplary embodiments relates to a CRUM unit which extracts power from a clock signal which is received from an image forming apparatus and an image forming apparatus using the same.

A Customer Replacement Unit Monitor (CRUM) unit which is mountable on a consumable unit of an image forming apparatus according to an exemplary embodiment includes a plurality of interfaces configured to be connected to the consumable unit, a power extracting circuit configured to, when a clock signal is received through one of the plurality of interfaces, extracts power from the clock signal, and an interface controller configured to transmit/receive data through at least one of the plurality of interfaces according to the clock signal, and the clock signal has a first pulse width in a data section where a data signal is received and has a second pulse width which is different from the first pulse width in an idle section where a data signal is not received.

The first pulse width of the clock signal may be greater than the second pulse width.

The interface controller, when it is determined that the idle section is changed to the data section based on the clock signal, may transmit/receive the data signal in the data section.

The interface controller, when a high value and a low value of the clock signal repeatedly alternate in the idle section and a section where one of the high value and the low value is maintained exceeds a predetermined first time, may determine that the idle section is changed to the data section, and when a high value and a low value of the clock signal repeatedly alternate in the data section and a section where one of the high value and the low value is maintained has the first time, may determine that the data section is changed to the idle section.

The interface controller, when a high value and a low value of the clock signal repeatedly alternate in the idle section and a section where a low value of the clock signal is maintained exceeds a predetermined first time, may determine that the time when the section exceeds the first time as a time when reception of the data signal starts, and when a high value and a low value of the clock signal repeatedly alternate in the data section or the idle section and a section where a high value of the clock signal is maintained exceeds a predetermined second time, may determine that the time when the section exceeds the second time as a time when reception of the data signal ends.

The power extracting circuit may extract the power using a clock signal having the first pulse width and a clock signal having the second pulse width, and the interface controller may transmit/receive the data signal corresponding to the data section based on the clock signal.

The CRUM unit may further include a memory and a controller configured to be activated by the power and manage the memory according the data signal which is transmitted/received to/from the interface controller.

The interface controller, the memory, and the controller may consist of at least one Integrated Chip (IC).

The power extracting circuit may include a diode configured to pass a clock signal having a high value out of the clock signal and a capacitor configured to be recharged by the clock signal which is passed from the diode.

The power extracting circuit may include a switching element configured to be connected to the interface and pass a clock signal having the high value by performing a switching operation according to the clock signal which is received through the interface and a capacitor configured to be recharged by the clock signal which is passed from the switching element.

The plurality of interfaces may include a first interface configured to receive the clock signal from a clock terminal provided on the consumable unit, a second interface configured to transmit/receive the data signal to/from a data terminal provided on the consumable unit, and a third interface configured to be connected to a ground terminal provided on the consumable unit.

The plurality of interfaces may include a first interface configured to receive the clock signal from a clock terminal provided on the consumable unit, a second interface configured to transmit/receive the data signal to/from a data terminal provided on the consumable unit, a third interface configured to be connected to a power terminal provided on the consumable unit, and a fourth interface configured to be connected to a ground terminal provided on the consumable unit, and the third interface may maintain an inactive state.

The plurality of interfaces may include a first interface configured to receive the clock signal from a clock terminal provided on the consumable unit, a second interface configured to transmit/receive the data signal to/from a first data terminal provided on the consumable unit, a third interface configured to transmit a data signal to the image forming apparatus through a second data terminal provided on the consumable unit, and a fourth interface configured to be connected to a ground terminal provided on the consumable unit.

The clock signal may have a clock wave form where a high value section and a low value section having the second pulse width repeatedly alternate in the idle section, and a size of the clock signal in the high value section may exceed ‘0’.

The clock signal may have a clock wave form where a high value section and a low value section having the second pulse width repeatedly alternate in the idle section, and a size of the clock signal in the low value section may be smaller than the high value.

An image forming apparatus according to an exemplary embodiment includes a main body configured to have a main controller which controls an operation of the image forming apparatus, a consumable unit configured to be mounted on the main body to enable communication with the main controller, and a CRUM unit configured to be provided on the consumable unit, and the main controller transmits a clock signal where a high value and a low value repeatedly alternate in a predetermined pattern in an idle section where a data signal is not received to the CRUM unit through the consumable unit, and the clock signal has a first pulse width in a data section where the data signal is received and a second pulse width which is a different from the first pulse width in the idle section.

The first pulse width of the clock signal may be greater than the second pulse width.

The consumable unit may include a data terminal configured to transmit/receive the data signal to/from the main controller, a clock terminal configured to receive the clock signal which is transmitted from the main controller, and a ground terminal.

The CRUM unit may include a first interface configured to transmit/receive the data signal to/from the data terminal, a second interface configured to receive the clock signal from the clock terminal, a power extracting circuit configured to, when the clock signal is received through the first interface, extract power from the clock signal, an interface controller configured to transmit/receive the data signal through at least one of the plurality of interfaces according to the clock signal, a memory, and a controller configured to be activated by the power and manage the memory according to the data signal which is transmitted/received to/from the interface controller.

The interface controller, when it is determined that the idle section is changed to the data section based on the clock signal, may transmit/receive the data signal in the data section.

The interface controller, when a high value and a low value of the clock signal repeatedly alternate in the idle section and a section where one of the high value and the low value is maintained exceeds a predetermined first time, may determine that the idle section is changed to the data section, and when a high value and a low value of the clock signal repeatedly alternate in the data section and a section where one of the high value and the low value is maintained has the first time, may determine that the data section is changed to the idle section.

The consumable unit may further include a power terminal, the CRUM unit may further include a third interface which is connected to the power terminal, and the third interface may maintain an inactive state at all times.

The consumable unit may further include an additional data terminal, and the CRUM unit may further include a third interface configured to transmit a data signal to the main controller through the additional data terminal.

A CRUM unit which is mountable on a consumable unit of an image forming apparatus according to an exemplary embodiment includes a plurality of interfaces configured to be connected to the consumable unit, a power extracting circuit configured to, when a clock signal is received through one of the plurality of interfaces, extracts power from the clock signal, and an interface controller configured to transmit/receive a data signal through at least one of the plurality of interfaces according to the clock signal, and the clock signal is a signal where a high value and a first low value repeatedly alternate in a data section where a data signal is received, and one of a high value and a second low value is maintained in an idle section where the data signal is not received, and the second low value exceeds ‘0’ and less than the high value.

The clock signal may be a signal where the high value and the first low value repeatedly alternate according to a predetermined first time in the data section, and one of the high value and the second low value may be maintained for a time which is longer than the first time in the idle section.

The interface controller, when it is determined that the idle section is changed to the data section based on the clock signal, may transmit/receive the data signal in the data section.

The interface controller, when high value of the clock signal is maintained and changed to the first low value in the idle section, may determine that a point of time when the high value is changed to the first low value as a point of time when reception of the data signal starts, and when a section where the high value of the clock signal is maintained exceeds the first time in the data section or the idle section, may determine the time as a point of time when reception of the data signal ends.

The interface controller, when one of a high value and a second low value of the clock signal is maintained longer than a first time in the idle section and the high value and the first low value have the first time, may determine that the idle section is changed to the data section, and when a high value and a first low value of the clock signal repeatedly alternate in the data section and a section where one of the high value and the second low value is maintained exceeds the first time, may determine that the data section is changed to the idle section.

The plurality of interfaces may include a first interface configured to receive the clock signal from a clock terminal provided on the consumable unit, a second interface configured to transmit/receive the data signal from a data terminal provided on the consumable unit, and a third interface configured to be connected to a ground terminal provided on the consumable unit.

The first low value may be the same as the second low value.

The first low value may be ‘0’.

A consumable unit which is mountable on an image forming apparatus according to an exemplary embodiment includes a first contact point configured to receive a clock signal from a main body of the image forming apparatus, a second contact point configured to transmit/receive a data signal to/from a main body of the image forming apparatus, a third contact point configured to be connected to a ground terminal of a main body of the image forming apparatus, and a CRUM unit configured to receive the clock signal and the data signal, and the CRUM unit extracts and uses power from the clock signal in an idle section where the data signal is not received, and the clock signal has a first pulse width in a data section where a data signal is received and a second pulse width which is different from the first pulse width in an idle section where data is not received.

A consumable unit which is mountable on an image forming apparatus according to an exemplary embodiment includes a first contact point configured to receive a clock signal from a main body of the image forming apparatus, a second contact point configured to transmit/receive a data signal to/from a main body of the image forming apparatus, a third contact point configured to be connected to a ground terminal of a main body of the image forming apparatus, and a CRUM unit configured to receive the clock signal and the data signal, and the CRUM unit extracts and uses power from the clock signal in an idle section where the data signal is not received, the clock signal is a signal where a high value and a low value repeatedly alternate in a data section where the data signal is received and one of the high value and the low value is maintained in the idle section, and the low value exceeds ‘0’ and less than the high value.

The invention extends to a method of extracting power from a clock signal in a Customer Replacement Unit Monitor, CRUM, unit which is mountable on a consumable unit of an image forming apparatus, the method comprising extracting and using power from the clock signal in an idle section in which a data signal is not received as described above.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a block diagram illustrating configuration of an image forming apparatus according to an exemplary embodiment;

FIG. 2 is a view illustrating a one side of a consumable unit illustrated in FIG. 1;

FIGS. 3 and 4 are views provided to explain a connection method between an image forming apparatus and a consumable unit;

FIG. 5 is a block diagram illustrating configuration of an image forming apparatus according to another exemplary embodiment;

FIG. 6 is a view illustrating a one side of the consumable unit illustrated in FIG. 3;

FIG. 7 is a block diagram illustrating configuration of a CRUM unit according to an exemplary embodiment;

FIG. 8 is a block diagram illustrating configuration of a CRUM unit according to another exemplary embodiment;

FIGS. 9A and 9B are circuit diagrams illustrating a power extracting circuit of the CRUM unit illustrated in FIG. 7;

FIG. 10 is a block diagram illustrating configuration of a CRUM unit according to another exemplary embodiment;

FIG. 11 is a block diagram illustrating configuration of a CRUM unit according to another exemplary embodiment;

FIGS. 12A to 12D are views provided to explain various examples of a data signal, a clock signal and a wave form according to a decoding signal;

FIG. 13 is a flowchart provided to explain a power extracting method of a CRUM unit according to an exemplary embodiment;

FIG. 14 is a flowchart provided to explain a power extracting method of a CRUM unit according to another exemplary embodiment; and

FIG. 15 is a flowchart provided to explain a power extracting method of a CRUM unit according to another exemplary embodiment.

### DETAILED DESCRIPTION

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

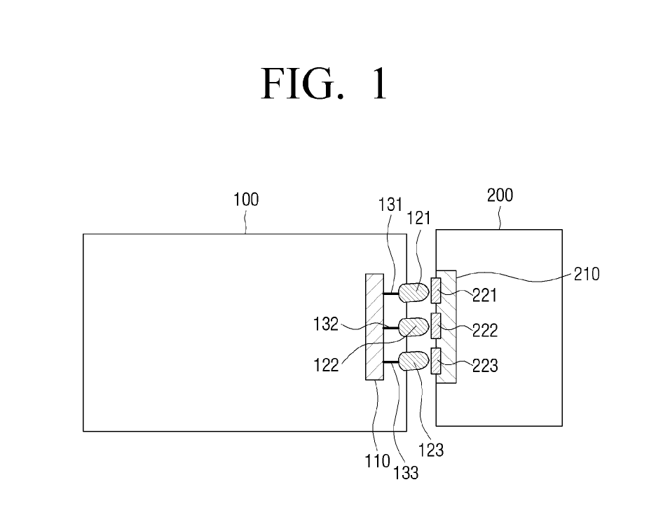

FIG. 1 is a block diagram illustrating configuration of an image forming apparatus according to an exemplary embodiment. According to FIG. 1, an image forming apparatus includes a main body 100, a main controller 110 and a consumable unit 200 which can be mounted on the main body 100. Herein, the image forming apparatus can be realized as various types of apparatuses which may form an image on various types of recording media like paper, such as a printer, a scanner, a Multi-Function Printer (MFP), a facsimile, a copier, etc.

The main controller 110 is mounted on the main body 100 of an image forming apparatus, and controls overall functions of the image forming apparatus.

The consumable unit 200 is mounted on the main body 100 of an image forming apparatus, and may be one of various types of unit which involve an image forming job directly or indirectly. For example, a laser image forming apparatus may include a consumable unit such as a charging unit, an exposure unit, a developer unit, a transfer unit, a fixing unit, various rollers, a belt, an OPC drum, etc., and other various types of unit which require replacement such as a developer (for example, a developer cartridge or a toner cartridge) in the process of using an image forming apparatus may be defined as the consumable unit 200.

As described above, there is a life expectancy for each consumable unit 200. Accordingly, the consumable unit 200 includes a CRUM unit 210 so that each consumable unit 200 may be replaced in time.

The CRUM unit 210 is an element which is mounted on the consumable unit 200 and records various information. The CRUM unit 210 may consist of only one chip or may consist of various elements which are integrated on a board.

The CRUM unit 210 includes a memory. Accordingly, the CRUM unit 210 may be referred to as various names such as a memory, a CRUM unit memory, etc., but it will be referred to as the CRUM unit 210 in this specification for convenience of explanation.

A memory provided on the CRUM unit 210 may store various properties information regarding the consumable unit 200, the CRUM unit 210 itself, the image forming apparatus, etc., and use information or a program for performing an image forming job.

Specifically, various programs which are stored in the CRUM unit 210 may include not only a general application but also an Operating System (O/S) program, an encryption program, etc. In addition, the properties information may include information regarding a manufacturer of the consumable unit 200, information regarding a manufacturer of the image forming apparatus, the name of mountable image forming apparatus, information regarding a manufacturing date, a serial number, a model name, an electronic signature information, an encryption key, an encryption key index, etc. Further, the use information may include information regarding how many papers have been printed so far, how many papers can be further printed, how much toner is left, etc. The properties information may also be referred to as intrinsic information.

For example, the CRUM unit 210 may include information as shown in the below table.

TABLE 1
General Information

| OS Version | CLP300_V1.30.12.35 02-22-2007 |
|---|---|
| SPL-C Version | 5.24 06-28-2006 |
| Engine Version | 6.01.00(55) |
| USB Serial Number | BH45BAIP914466B. |
| Set Model | DOM |
| Service Start Date | 2007-09-29 |

Option

| | |
|---|---|
| RAM Size | 32 Mbytes |
| EEPROM Size | 4096 bytes |
| USB Connected (High) | |

Consumables Life

| | |
|---|---|
| Total Page Count | 774/93 Pages(Color/mono) |
| Fuser Life | 1636 Pages |
| Transfer Roller Life | 864 Pages |
| Tray1 Roller Life | 867 Pages |
| Total Image Count | 3251 Images |
| Imaging Unit/Deve Roller Life | 61 Images/19 Pages |
| Transfer Belt Life | 3251 Images |
| Toner Image Count | 14/9/14/19 Images(C/M/Y/K) |

Toner Information

| | |
|---|---|
| Toner Remains Percent | 99%/91%/92%/100% (C/M/Y/K) |
| Toner Average Coverage | 5%/53%/31%/3% (C/M/Y/K) |

Consumables Information

| | |
|---|---|
| Cyan Toner | SAMSUNG(DOM) |
| Magenta Toner | SAMSUNG(DOM) |
| Yellow Toner | SAMSUNG(DOM) |
| Black Toner | SAMSUNG(DOM) |
| Imaging unit | SAMSUNG(DOM) |

Color Menu

| | |
|---|---|
| Custom Color | Manual Adjust(CMYK: 0,0,0,0) |

Setup Menu

| | |
|---|---|
| Power Save | 20 Minutes |
| Auto Continue | On |
| Altitude Adj. | Plain |

As shown in the above table, the memory of the CRUM unit 210 may include not only brief information regarding the consumable unit 200 but also information regarding the life of consumables, information, a setup menu, etc. In addition, the memory may also store an O/S which is provided separately from the main body of the image forming apparatus in order to be used in a consumable unit.

In addition, the CRUM unit 210 may further include a CPU (not shown) which manages a memory, executes various programs stored in the memory, and performs communication with the main body of the image forming apparatus or controllers of other apparatuses.

Meanwhile, if the consumable unit 200 including the CRUM unit 210 is mounted on the main body 100 of the image forming apparatus, the CRUM unit 210 communicates with the main controller 110 through the consumable unit 200.

The main body 100 of the image forming apparatus includes three terminals 121, 122, 123, each respectively connected by cables 131, 132, 133 are connected to the main controller 110.

In addition, the consumable unit 200 also includes three terminals 221, 222, 223 which are inter-connected to the three terminals 121, 122, 123 included in the main body 100. As the three terminals 221, 222, 223 are connected to the CRUM unit 210, the CRUM unit 210 communicates with the main controller 110 through the three terminals 221, 222, 223 included in the consumable unit 200.

Meanwhile, the three terminals 121, 122, 123 included in the main body 100 may be a clock terminal, a data terminal and a ground terminal, respectively. Likewise, the three terminals 221, 222, 223 included in the consumable unit 200 may also be a clock terminal, a data terminal and a ground terminal, respectively.

The clock terminal 221 of the consumable unit 200 may be connected to a clock terminal 121 included in the main body 100 of the image forming apparatus and may receive a clock signal. In addition, the data terminal 222 of the consumable unit 200 may be connected to a data terminal 122 included in the main body 100 of the image forming apparatus and may transmit/receive a data signal. The ground terminal 223 of the consumable unit 200 is connected to a ground terminal 123 included in the main body 100 of the image forming apparatus.

Meanwhile, when a clock signal is received through the clock terminal 221, the CRUM unit 210 extracts power from the clock signal.

The method of extracting power may be realized in various ways according to the wave form of clock signal. In addition, the wave form of clock signal may vary depending on a data section where a data signal is received and an idle section where a data signal is not received.

According to the first exemplary embodiment, a clock signal may have a clock wave form where a high value and a low value repeatedly alternate in a predetermined pattern in an idle section.

That is, a clock signal may maintain a clock wave form even in an idle section. In this case, a clocks signal in a data section may have a first pulse width, and a clock signal in an idle section may have a second pulse width which is different from the first pulse width. Herein, the first pulse width may be set to be greater than the second pulse width, but is not limited thereto.

In addition, a frequency of a clock signal in the data section (that is, a first clock frequency) may be different from a frequency of a clock signal in the idle section (that is, a second clock frequency).

Specifically, a high value and a low value of a clock signal repeatedly alternate by a predetermined first time unit in the idle section, and a high value and a low value of a clock signal repeatedly alternate by a predetermined second time unit which is set to be longer than the first time unit in the data section. Herein, the high value may be 3V to 4V. The low value may exceed ‘0’, but smaller than the high value. The low value may be ‘0’.

According to the first exemplary embodiment, a clock signal includes a high value in the idle section and the data section and thus, the CRUM unit 210 may extract power from the high value of a clock signal in the idle section and the data section and operates accordingly. In particular, as the high value and the low value of a clock signal repeats by the first time unit in the idle section, power may be extracted from the high value repeatedly and drive the CRUM unit 210 continuously without any pause in the supply of power.

According to the second exemplary embodiment, the high value and a first low value of a clock signal repeatedly alternate by the predetermined first time unit in the data section, and either one of the high value and a second low value is maintained in the idle section for a time which is longer than the first time. Herein, the high value may be 3V to 4V. The second low value may exceed ‘0’, but smaller than the high value. In addition, the first low value may be the same as the second low value, or may be ‘0’.

According to the second exemplary embodiment, a clock signal is maintained at the second low value which exceeds ‘0’ in the idle section and includes a high value in the data section and thus, power may be extracted from the second low value in the idle section and power may be extracted from the high value in the data section for operation.

On the other hand, the CRUM unit 210 may receive a clock signal where one of the high value and the second low value is maintained consistently for a the second time which is longer than the first time in the idle section. Accordingly, in the idle section, power may be extracted from either one of the high value and the second low value of the clock signal which is maintained consistently in the corresponding section.

The CRUM unit 210 according to the above-described exemplary embodiments may be activated by the power extracted from the idle section and the data section. In addition, the CRUM unit 210 may transmit/receive a data signal according to a clock signal in the data section, and may manage a memory according to the data signal.

As described above, according to an exemplary embodiment, the CRUM unit 210 may be activated without a power terminal, by extracting power from a clock signal which the CRUM unit 210 receives through the clock terminal 221.

In addition, the CRUM unit 210 does not have to include an interface in order to be connected with a power terminal and thus, the cost of the CRUM unit 210 may be reduced as the size of the CRUM unit 210 and the number of interface is reduced.

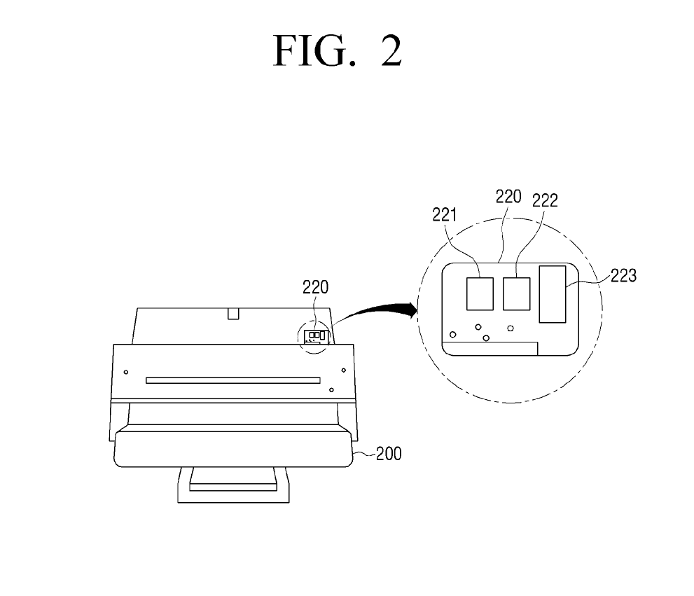

FIG. 2 is a view illustrating a one side of a consumable unit illustrated in FIG. 1.

According to FIG. 2, the consumable unit 220 includes a terminal unit 220 for communication with the main controller 110 which is provided on an image forming apparatus. The terminal unit 220 may include the clock terminal 221, the data terminal 222 and the ground terminal 223 as illustrated in FIG. 1.

The clock terminal 221, the data terminal 222 and the ground terminal 223 are a contact type, and they are connected electrically to the three terminals 121, 122, 123 provided on the main body 100 of the image forming apparatus in contact with one another.

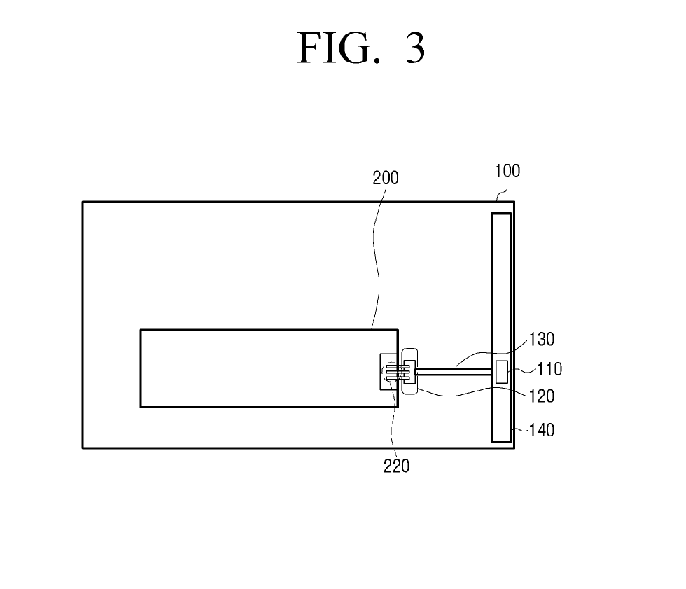

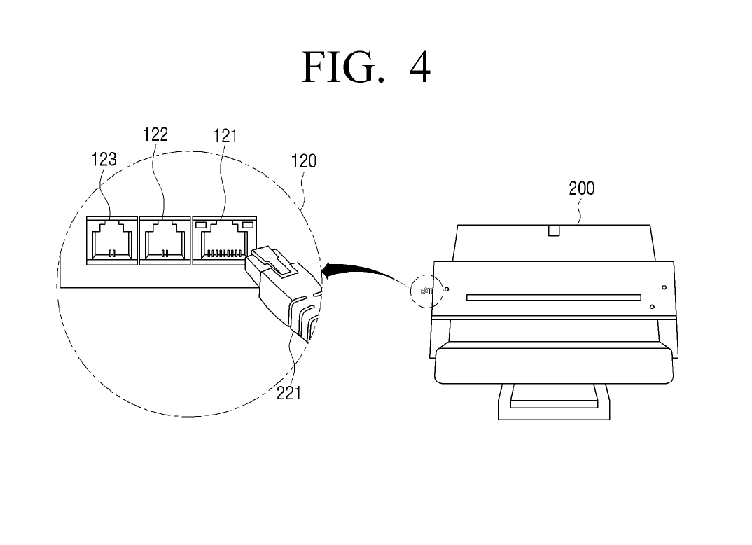

FIGS. 3 and 4 are views provided to explain a connection method between an image forming apparatus and a consumable unit.

FIG. 3 is a view illustrating a connection state between the consumable unit 200 which is realized in a contact type and the main body 100 of an image forming apparatus. According to FIG. 3, the main body 100 of the image forming apparatus includes a terminal unit 120, a main board 140 where various parts including the main controller 110 are disposed, and a connection cable 130 for connecting the main board 140 with the terminal unit 120.

As illustrated in FIG. 3, when the consumable unit 200 is mounted on the main body 100, the terminal unit 220 included in the consumable unit 200 is connected electrically with the terminal unit 210 of the main body 100 as they are in contact with each other naturally.

FIG. 4 is a view illustrating an example of external configuration of the terminal unit 220 which is realized in a connector type. According to FIG. 4, the main body 100 of the image forming apparatus includes the terminal unit 120 in a port type where a connector may be inserted. The terminal unit 120 includes three terminals 121, 122, 123.

The consumable unit 200 may include the clock terminal 221 in a connector type. The clock terminal 221 is inserted to the clock terminal 221 provided on the terminal unit 120.

In addition, albeit not illustrated in the drawing, the consumable unit 200 further includes the data terminal 222 and the ground terminal 223 which are in a connector type, and they are inserted to the data terminal 122 and the ground terminal 123 which are provided on the terminal unit 120, respectively.

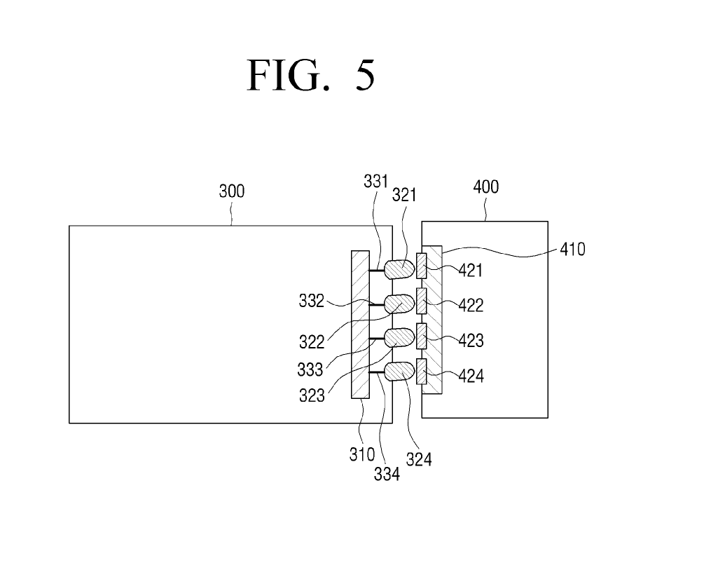

FIG. 5 is a block diagram illustrating configuration of an image forming apparatus according to another exemplary embodiment.

In FIG. 1, the main body 100 of the image forming apparatus and the consumable unit 200 include three terminals 121, 122, 123, 221, 222, 223, respectively, but the main body 100 of the image forming apparatus and the consumable unit 200 may further include a power terminal. That is, the main body 100 of the image forming apparatus and the consumable unit 200 may include four terminals, respectively.

According to FIG. 5, an image forming apparatus includes a main body 300, a main controller 310 which is provided on the main body 300 and a consumable unit 400 which can be mounted on the main body 300.

As shown in FIG. 5, if the consumable unit 400 including the CRUM unit 410 is mounted on the main body 300 of the image forming apparatus, the CRUM unit 410 communicates with the main controller 310 through the consumable unit 400.

The main controller 310 may electrically connect to the consumable unit 400 through four terminals 321, 322, 323, 324 provided on the main body 100 and cables 331, 332, 333, 334 which are connected to each terminal 321, 322, 323.

In addition, the consumable unit 400 includes four terminals 421, 422, 423, 424 which are in contact with four terminals 321, 322, 323, 324 of the main body 300.

According to an exemplary embodiment, the four terminals 321, 322, 323, 324 included in the main body 300 may be a clock terminal, a data terminal, a power terminal, and a ground terminal, respectively. Likewise, the four terminals 421, 422, 423, 424 included in the consumable unit 400 may also be a clock terminal, a data terminal, a power terminal, and a ground terminal, respectively.

Meanwhile, the clock terminal 421 of the consumable unit 400 may be connected to the clock terminal 321 included in the main body 300 of the image forming apparatus and may receive a clock signal. In addition, the data terminal 422 of the consumable unit 400 may be connected to the data terminal 322 included in the main body 300 and may transmit/receive a data signal. The power terminal 423 of the consumable unit 400 may be connected to the power terminal 223 included in the main body 300, and the ground terminal 424 of the consumable unit 400 may be connected to the ground terminal 224 included in the main body 300.

The power terminal 323 included in the main body 300 of the image forming apparatus is always maintained in an inactive state. That is, the power terminal 323 is not a terminal for supplying power.

In an image forming apparatus which is standardized with four terminals, the consumable unit 200 and the CRUM unit 210 illustrated in FIG. 1 cannot be used. Accordingly, the main body 310 of the image forming apparatus may be configured to include four terminals to conform to the standard of the image forming apparatus while the power terminal 323 is configured to be turned off electrically.

In addition, the consumable unit 400 may be standardized with four terminals to correspond to the image forming apparatus. Accordingly, the consumable unit 400 may also include four terminals 421, 422, 423, 424.

Meanwhile, the CRUM unit 410 may include a plurality of interfaces (not shown) to be connected to the four terminals 421, 422, 423, 424 included in the consumable unit 400. One of the plurality of interfaces may be connected to the power terminal 423 included in the consumable unit 400. However, this interface may be maintained in an inactive state as it is turned off electrically with respect to the CRUM unit 410.

As the main body 300 of the image forming apparatus and the consumable unit 400 according to an exemplary embodiment include power terminals 323, 423 which are maintained in an inactive state, they do not provide or receive power through the power terminals 323, 423. Accordingly, power consumption of the image forming apparatus may be reduced.

Meanwhile, it is general that an image forming apparatus and a consumable unit which are currently commercialized include four terminals of a clock terminal, a data terminal, a power terminal, and a ground terminal, respectively. Therefore, if only a protocol which is related to a clock signal stored in the main controller of an image forming apparatus currently commercialized is changed or updated, the CRUM 410 according to an exemplary embodiment may be mounted and used. Accordingly, the existing CRUM unit may be compatible with the CRUM unit 410.

Meanwhile, according to another exemplary embodiment, the four terminals 321, 322, 323, 324 included in the main body 300 of the image forming apparatus may be a clock terminal, a first data terminal, a second data terminal, and a ground terminal, respectively. Likewise, the four terminals 421, 422, 423, 424 included in the consumable unit 400 may also be a clock terminal, a first data terminal, a second data terminal, and a ground terminal, respectively.

The clock terminal 421 of the consumable unit 400 may be connected to the clock terminal 321 included in the main body 300 of the image forming apparatus and may receive a clock signal. In addition, the first data terminal 422 of the consumable unit 400 may be connected to the first data terminal 322 included in the main body 300 of the image forming apparatus and may transmit/receive a data signal. The second data terminal 423 of the consumable unit 400 may be connected to the second data terminal 223 included in the main body 300 of the image forming apparatus, and the ground terminal 424 of the consumable unit 400 may be connected to the ground terminal 424 included in the main body 300 of the image forming apparatus.

The main body 300 of the image forming apparatus and the consumable unit 400 include two data terminals 222, 223 and 422, 423, respectively, and thus, may transmit and the main controller 310 and the CRUM unit 410 may transmit and receive a data signal through the data terminals 222, 422, and 223, 423 which are in connection with each other.

Specifically, when the main controller 310 transmits a data signal to the CRUM unit 410, the main controller 310 may transmit the data signal through the first data terminal 322. According to such an operation, the CRUM unit 410 may transmit/receive the data signal through the first data terminal 422 which is connected to the first data terminal 322.

On the other hand, when the CRUM unit 410 transmits a data signal to the main controller 310, the CRUM unit 410 may transmit the data signal through the second data terminal 423. According to such an operation, the main controller 310 may transmit/receive the data signal through the second data terminal 323 which is connected to the second data terminal 423.

Meanwhile, in the above-described exemplary embodiments, when a clock signal is received through the clock terminal 421, the CRUM unit 410 extracts power from the clock signal. The method of sampling power may be realized in various ways as described above with reference to FIG. 1.

Therefore, whether a power terminal is included or not included in the main body 200 of the image forming apparatus and the consumable unit 400, the CRUM unit 210 may extract and activate power from a clock signal.

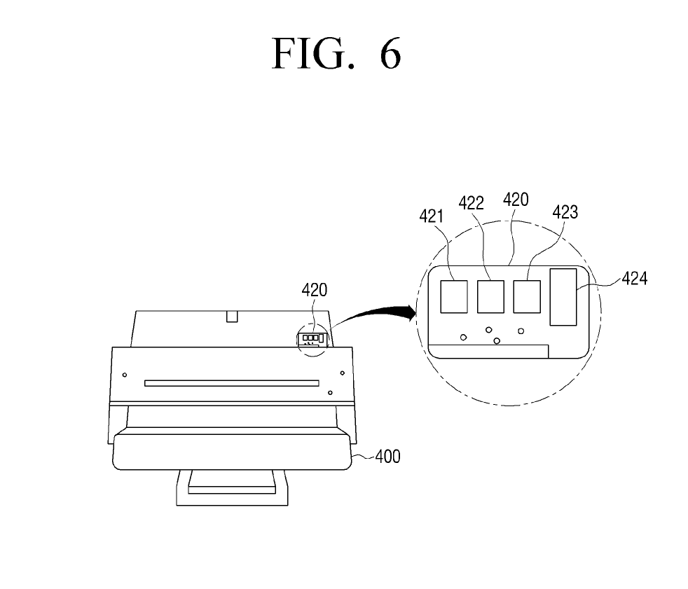

FIG. 6 is a view illustrating a one side of the consumable unit illustrated in FIG. 5.

According to FIG. 6, the consumable unit 400 includes a terminal unit 420 for communication with the main controller 310 which is provided in an image forming apparatus.

In order to be connected with the four terminals 321, 322, 323, 324 included in the main body 300 of the image forming apparatus, the terminal unit 420 may include four terminals 421, 422, 423, 424.

That is, the terminal unit 420 may further include another terminal 423 in addition to the clock terminal 421, the data terminal 422 and the clock terminal 424, and this additional terminal 423 may be a power terminal or an additional data terminal depending on exemplary embodiments.

The above four terminals 421, 422, 423, 424 are a connect type, and they are electrically connected to the four terminals 421, 422, 423, 424 of the main body 300 of the image forming apparatus in contact with each other.

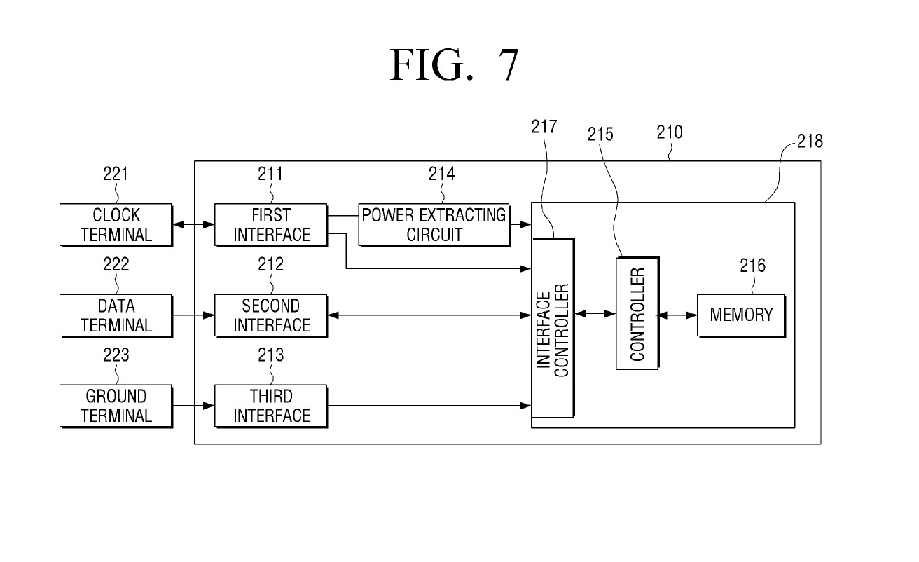

FIG. 7 is a block diagram illustrating configuration of a CRUM unit according to an exemplary embodiment.

According to FIG. 7, the CRUM unit 210 includes a first to a third interfaces 211, 212, 213, a power extracting circuit 214, an interface controller 217, a controller 215, and a memory 216. Herein, the interface controller 217, the controller 215 and the memory 216 belong to a control unit 218, and they may be configured as one Integrated Circuit (IC) or may be distributed to a plurality of ICs.

The first to the third interfaces 211, 212, 213 are connected to the clock terminal 221, the data terminal 222 and the ground terminal 223 included in the consumable unit, respectively and communicate with the image forming apparatus.

Specifically, the first interface 211 receives a clock signal from the image forming apparatus through the clock terminal 221, and the second interface 212 receives a data signal from the image forming apparatus through the data terminal 222. In addition, the third interface 213 is connected to the ground terminal 223.

The power extracting circuit 214 is connected to the first interface 211, and when a clock signal is received through the first interface 211, extracts power from the clock signal. The clock signal may have a different wave form according to a section of a data signal which is received through the second interface 212, and may be realized in various forms.

According to the first exemplary embodiment, the second interface 212 may have a first pulse width in the data section where a data signal is received, and may have a second pulse width which is different from the first pulse width in the idle section where a data signal is not received. In this case, it is desirable that the first pulse width is greater than the second pulse width.

In addition, the frequency of a clock signal in the data section may be different from the frequency of a clock signal in the idle section. Specifically, a clock signal may have a wave form in which a high value and a low value repeatedly alternate by a predetermined first time unit in the idle section, and a high value and a low value repeatedly alternate by a predetermined second time unit which is set to be longer than the first time unit in the data section.

If a clock signal according to the first exemplary embodiment is received, the power extracting circuit 214 may extract power from the high value in the idle section and the data section. Herein, the high value may be 3V to 4V. In addition, the low value may exceed ‘0’, but smaller than the high value. Alternatively, the low value may be ‘0’.

If a low value exceeds ‘0’ but smaller than the high value in the idle section and the data section in the first exemplary embodiment, power may be extracted from the low value.

Meanwhile, according to the second exemplary embodiment, a clock signal may have a wave form in which a high value and a first low value repeatedly alternate by a predetermined first time unit in the data section, and one of a high value and a second low value is maintained for a time which is longer than the first time unit the idle section.

If a clock signal according to the second exemplary embodiment is received, the power extracting circuit 214 may extract power from the high value in the data section, and extract power from one of the high value and the second low value which is maintained consistently in the idle section. Herein, the high value may be 3V to 4V. In addition, the second low value may exceed ‘0’, but smaller than the high value. The first low value may be the same as the second low value, or may be ‘0’.

In the second exemplary embodiment, if the first low value is the same as the second low value in the data section, power may be extracted from the first low value in the data section.

The interface controller 217 is activated by the power which is extracted by the power extracting circuit 214. The interface controller 217 transmit and receive data through at least one of the first to the third interfaces 211, 212, 213 according to a clock signal.

First of all, when a clock signal is received through the first interface 211, the interface controller 217 checks the clock signal and determine a point of time when a data section is changed to an idle section or a point of time when the idle section to the data section.

Specifically, when a clock signal according to the first exemplary embodiment is received, the interface controller 217 determines that the idle section is changed to the data section if a high value and a low value of the clock signal repeatedly alternate in the idle section, and the section where one of the high value and the low value is maintained exceeds the first time.

In addition, when a clock signal according to the first exemplary embodiment is received, the interface controller 217 determines that the data section is changed to the idle section if a high value and a low value repeatedly alternate in the data section, and the section where one of the high value and the low value has the first time.

If it is determined that the idle section is changed to the data section, the interface controller 217 may receive a data signal which is received during the data section through the second interface 212. In this data section, a predetermined data signal may be transmitted from the CRUM unit to the image forming apparatus.

Meanwhile, the controller 215 may be activated by power, and may manage the memory 216 according to a data signal which is received/transmitted from/to the interface controller 217. That is, the controller 215 may store a data signal received from the interface controller 217 in the memory 216, and may read out data stored in the memory 216 and transmit a data signal to the image forming apparatus.

Meanwhile, usually, the CRUM unit 210 and the image forming apparatus are connected in a stand-by state, but in order to transmit/receive a data signal, they need to be connected in an active state. Accordingly, a clock signal may include a signal section to inform the CRUM unit 210 of the point of time when the reception of a data starts.

Specifically, if a high value and a low value of a clock signal repeatedly alternate by the first time unit in the idle section, and a section where the low value of the clock signal is maintained exceeds the first time, the interface controller 217 may determine that the point of time when the first time exceeds may be the time when the reception of a data signal starts.

In addition, when the transmission/reception of a data signal between the CRUM unit 210 and the image forming apparatus is completed, the CRUM unit 210 and the image forming apparatus need to end the active state and be connected in the stand-by state. Accordingly, the clock signal may include a signal section to inform the CRUM unit 210 of the point of time when the reception of the data signal ends.

Specifically, if a high value and a low value of a clock signal repeatedly alternate by the second time unit in the data section, and a section where the high value of the clock signal is maintained exceeds the second time, the interface controller 217 may determine that the point of time when the second time exceeds may be the time when the reception of a data signal ends.

Alternatively, if a high value and a low value of a clock signal repeatedly alternate by the first time unit in the idle section, and a section where the high value of the clock signal is maintained exceeds the second time, the interface controller 217 may determine that the point of time when the second time exceeds may be the time when the reception of a data signal ends.

Meanwhile, when a clock signal according to the second exemplary embodiment is received, the interface controller 217 may determine that the idle section is changed to the data section if one of the high value and the second low value of the clock signal is maintained longer than the first time in the idle section and the high value and the first low value has the first time.

In addition, when a clock signal according to the second exemplary embodiment is received, the interface controller 217 may determine that the data section is changed to the idle section if the high value and the first low value of the clock signal repeatedly alternate in the data section and a section where one of the high value and the second low value has the first time.

Meanwhile, when the CRUM unit 210 receives a clock signal according to the second exemplary embodiment, the clock signal may include a signal section to inform the start of receiving a data signal and the end of receiving a data signal.

Specifically, when the high value of the clock signal is maintained longer than the first time and changed to the first low value in the idle section, the point of time when the high value is changed to the first low value may be determined as the point of time when the reception of a data signal starts.

In addition, when the high value and the first low value repeatedly alternate by the first time unit in the idle section and a section where the high value of the clock signal is maintained exceeds the first time, the interface controller 217 may determine that the point of time when the high value of the clock signal exceeds the first time as the point of time when the reception of a data signal ends.

Alternatively, when the first low value of the clock signal is maintained in the idle section and changed to a high value of the clock signal, and a section where the high value of the clock signal is maintained exceeds the first time, the interface controller 217 may determine that the point of time when the high value of the clock signal exceeds the first time may be the time when reception of a data signal ends.

As described above, according to an exemplary embodiment, the CRUM unit 210 may operate without any separate power terminal by extracting power from a clock signal which is received through the first interface 211. As such, the CRUM unit 210 does not have to include an interface for connecting with a power terminal and thus, the size of the CRUM unit 210 and the number of interface may be reduced.

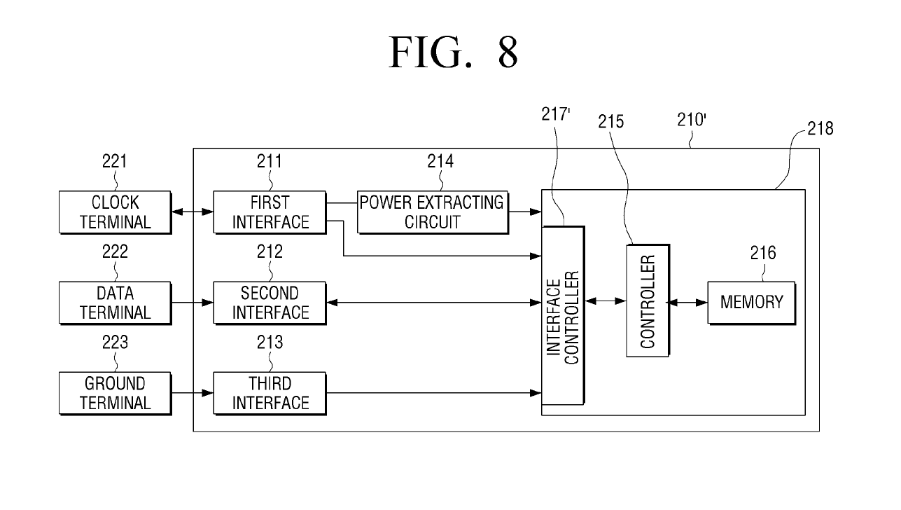

FIG. 8 is a block diagram illustrating configuration of a CRUM unit according to another exemplary embodiment. According to FIG. 8, the CRUM unit 210′ includes the first to the third interfaces 211, 212, 213, the power extracting circuit 214, an interface controller 217′, the controller 215, and the memory 216. Herein, all elements except for the interface controller 217′ are the same as those elements of the CRUM unit 210 illustrated in FIG. 7 and thus, specific description of each element will not be provided.

Referring to FIG. 8, the power extracting circuit 214 extracts power from a clock signal which is received through the first interface 211.

Meanwhile, the interface controller 217′ may generate a decoding signal by decoding a data signal corresponding to a data section based on the clock signal.

Specifically, the interface controller 217′ may decode a data signal according to the first exemplary embodiment. The clock signal according to the first exemplary embodiment may have the first pulse width in the data section and the second pulse width in the idle section. In addition, the clock signal has a clock wave form where a high value and a low value repeatedly alternate by the first time unit in the idle section and a clock wave form where the high value and the low value repeatedly alternate by the second time unit in the data section.

The interface controller 217 may generate a decoding signal where one of “0” and “1” is maintained consistently in the idle section and one of “0” and “1” repeatedly alternates in the data section by decoding data received from the data section based on the clock signal.

Meanwhile, the interface controller 217 may generate a decoding signal where one of “0” and “1” repeatedly alternates in the data section and one of “0” and “1” is maintained consistently in the idle section by decoding the data signal based on the clock signal according to the second exemplary embodiment.

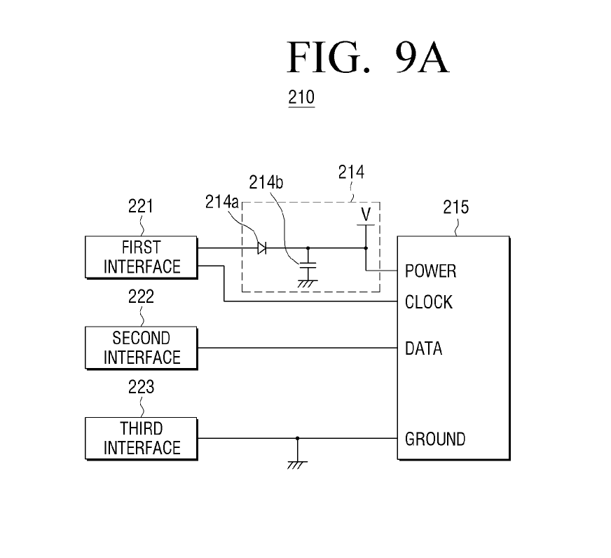

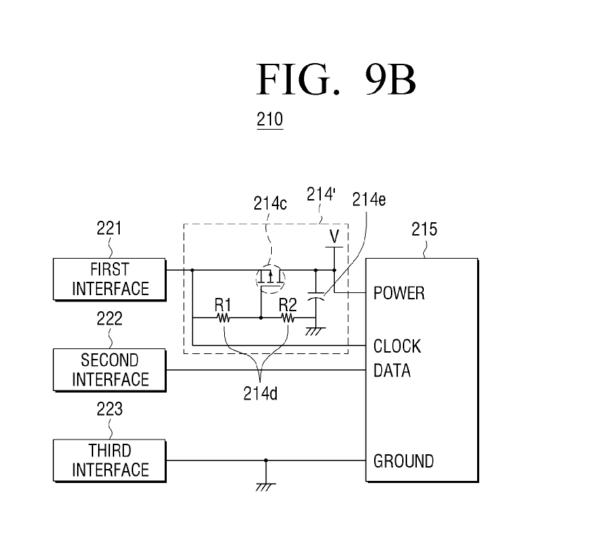

FIGS. 9A and 9B are circuit diagrams illustrating a power extracting circuit of the CRUM unit illustrated in FIG. 7. As illustrated in FIG. 9A, the power extracting circuit 214 extracts power from a clock signal, and may include a diode 214a and a capacitor 214b.

The diode 214a is connected to the first interface 211, and receives a clock signal from the first interface 221. The diode 214a may pass a clock signal having a high value in the idle section and the data section, respectively.

The capacitor 214b may be recharged by the clock signal which is passed from the diode 214a. Accordingly, the CRUM unit 210 may operate by using power which is recharged in the capacitor 214b.

Meanwhile, in the above exemplary embodiment, the diode 214a passes a clock signal having a high value in the idle section and the data section, respectively, but this is only an example. For example, if a clock signal according to the second exemplary embodiment is received, a clock signal having a high value may be passed in the data section, and a clock signal having the second low value may be passed in the idle section. In this case, the second low value may exceed “0” and less than the high value. In addition, the second low value may have power enough to drive the CRUM unit 210, and may be 2.7V to 3.0V.

Meanwhile, the power extracting circuit 214 is not limited to FIG. 9A, and may have a structure illustrated in FIG. 9B. Referring to FIG. 9B, a power extracting circuit 214′ extracts power from a clock signal, and may include a switching element and a capacitor 214e.

The switching element include a field effect transistor 214c and two resistors 213d. The switching element is connected to the first interface 211, and receives a clock signal from the first interface 221. The switching element may pass a clock signal having a high value by switching on/off according to the clock signal.

The capacitor 214e may be recharged by the clock signal which is passed from the switching element. Accordingly, the CRUM unit 210 may operate by using the power which is recharged in the capacitor 214e.

Meanwhile, in the above exemplary embodiment, a high value is passed as the switching element switches on in a high value section of a clock signal having a high value in the idle section and the data section, respectively, but this is only an example. For example, if a clock signal according to the second exemplary embodiment is received, a clock signal having a high value may be passed in the data section, and a clock signal having a high value or the second low value may be passed in the idle section.

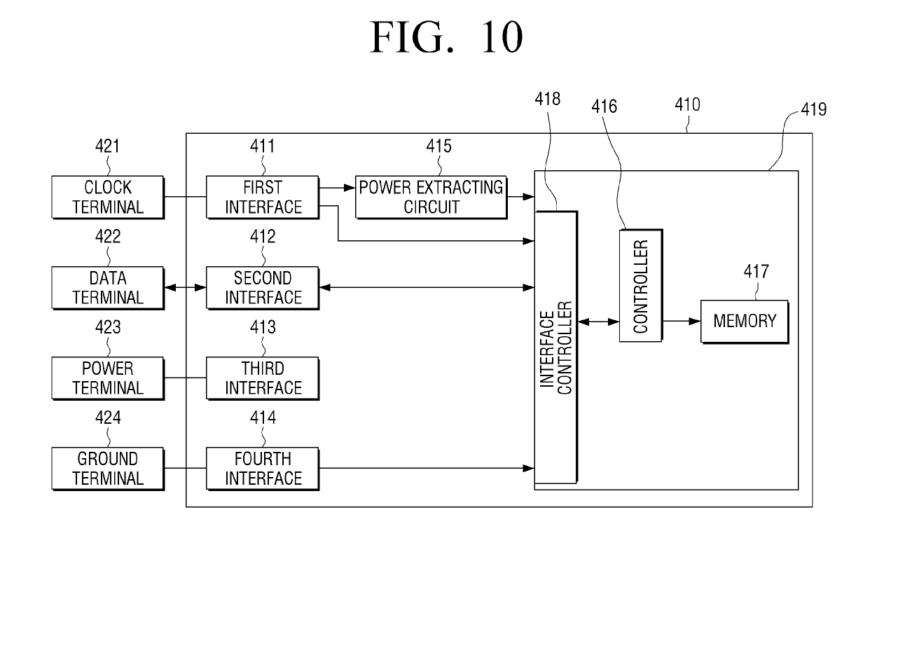

FIG. 10 is a block diagram illustrating configuration of a CRUM unit according to another exemplary embodiment. According to FIG. 10, the CRUM unit 410 includes a first to a fourth interfaces 411, 412, 413, 414, a power extracting circuit 415, an interface controller 418, a controller 416, and a memory 417. Herein, the interface controller 418, the controller 416 and the memory 417 belong to a control unit 419, and may be consist of at least one IC.

A consumable unit may be standardized with four terminals 421, 422, 423, 424. Accordingly, the CRUM unit 410 may include four interfaces 411, 412, 413, 414 in accordance with the consumable unit.

The first to the fourth interfaces 411, 412, 413, 414 are connected to the clock terminal 421, the data terminal 422, the power terminal 423, and the ground terminal 424, respectively, which are included in the consumable unit for communication with an image forming apparatus.

Specifically, the first interface 411 receives a clock signal from the image forming apparatus through the clock terminal 421, and the second interface 412 receives a data signal from the image forming apparatus through the data terminal 422. In addition, the third interface 413 is connected to the power terminal 423, and the fourth interface 414 is connected to the ground terminal 424.

Meanwhile, the first interface 411 are connected to the power extracting circuit 415 and the interface controller 418, and transmits a clock signal to the power extracting circuit 415 and the interface controller 418. In addition, the second interface 412 is connected to the interface controller 418, and transmits a data signal to the interface controller 418. The fourth interface 414 may be connected to a ground of a circuit which is included in the interface controller 418.

However, the third interface 413 is electrically turned off with respect to the elements included in the CRUM unit 410, and may be maintained in an inactive state at all times. In addition, the third interface 413 is connected to the power terminal, but does not receive power from the power terminal 423.

That is, according to an exemplary embodiment, the CRUM unit t 410 extracts power from a clock signal and thus, does not need to receive power through the power terminal 423. However, as described above with reference to FIG. 5, the third interface 413 which is connected to the power terminal 423 may be provided in the CRUM unit 410 to conform to the standard of the consumable unit 400 including four terminals, but the third interface 413 may be maintained in an inactive state. That is, the third interface 413 may be provided only to conform to the standard of the consumable unit 400 and thus, may not perform any operation with respect to the CRUM unit 410.

The power extracting circuit 415 extracts power from a clock signal which is received through the first interface 411. Herein, the clock signal may have a different wave form according to whether it is an idle section where a data signal is not received or it is a data section whether a data signal is received, and may be realized in various ways.

The various exemplary embodiments of a clock signal and the method of extracting power from a clock signal are the same as those in FIG. 7 where a clock signal according to the first and the second exemplary embodiments is described and thus, further description will not be provided.

The interface controller 418 is activated by the power which is extracted by the power extracting circuit 415. The interface controller 418 transmits/receives data through at least one of the first to the third interfaces 211, 212, 213 according to a clock signal.

When it is determined that the idle section is changed to the data section, the interface controller 418 may manage the memory 417 by transmitting/receiving a data signal according to the clock signal.

In addition, when it is determined that the data section is changed to the idle section, the interface controller 418 may control the power extracting circuit 415 to extract power from the clock signal in the idle section.

As described above, according to an exemplary embodiment, the CRUM unit 410 may conform to the standard of the consumable unit 400 consisting of four terminals by including the third interface 413 which is maintained in an inactive state.

Meanwhile, the CRUM unit 410 may be mounted on a consumable unit consisting of four terminals which are currently commercialized and may be compatible with the existing CRUM unit 410.

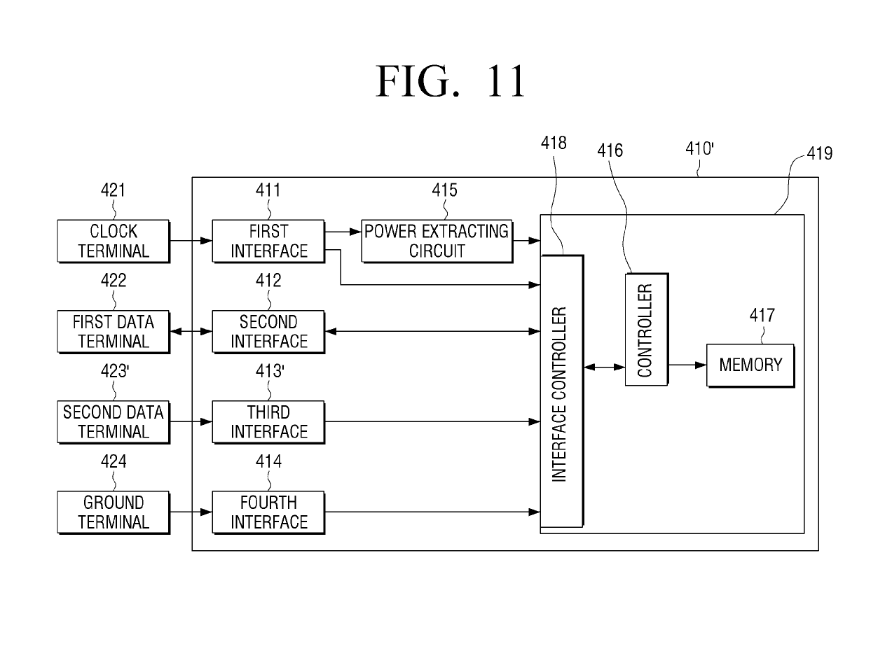

FIG. 11 is a block diagram illustrating configuration of a CRUM unit according to another exemplary embodiment. According to FIG. 11, a CRUM unit 410′ includes the first to the fourth interfaces 411, 412, 413′, 414, the power extracting circuit 415, the interface controller 418, the controller 416, and the memory 417.

The consumable unit may be standardized with four terminals 421, 422, 423′, 424. Accordingly, the CRUM unit 410′ may include four interfaces 411, 412, 413′, 414 in accordance with the consumable unit.

The first to the fourth interfaces 411, 412, 413′, 414 are connected to the clock terminal 421, the first data terminal 422, the second data terminal 423′, and the ground terminal 424, respectively, for communication with an image forming apparatus.

Specifically, the first interface 411 receives a clock signal from the image forming apparatus through the clock terminal 421, and the fourth interface 414 is connected to the ground terminal 424.

Meanwhile, the second interface 412 receives a data signal from the image forming apparatus through the first data terminal 422. In addition, the third interface 413′ transmits/receives a data signal to/from the image forming apparatus through the second data terminal 423′. That is, the second and the third interfaces 412, 413′ may transmits/receives a data signal to/from the image forming apparatus through the first and the second data terminals 422, 423′.

Specifically, if the image forming apparatus transmits a data signal to the CRUM unit 410′, the second interface 412 may receive the data signal through the first data terminal 422. On the other hand, if the CRUM unit 410′ transmits a data signal to the image forming apparatus, the third interface 413′ may receive the data signal through the second data terminal 423′.

Accordingly, the CRUM unit 410′ may reduce data traffic by receiving and transmitting a data through a different interface.

Meanwhile, in the above exemplary embodiment, the second and the third interfaces 412, 413′ receive and transmit a data signal, respectively, but this is only an example. For example, only one of the second and the third interfaces 412, 413′ may be selected and then, a data signal may be transmitted/received. If the size of a data signal is not significant, a data signal may be transmitted/received using only one interface. Alternatively, when there is a communication error in one of the second and the third interfaces 412, 413′, a data signal may be transmitted/received using the interface which is capable of perform communication.

When a clock signal is received through the first interface 411, the power extracting circuit 415 extracts power from the clock signal. Herein, the clock signal may have a different wave form according to a section of a data signal which is received through the second interface 412, and may be realized in various ways. The various exemplary embodiments of a clock signal and the method of extracting power from a clock signal are the same as those in FIG. 7 where a clock signal according to the first and the second exemplary embodiments is described and thus, further description will not be provided.

The controller 416 is activated by the power which is extracted by the power extracting circuit 415, and manages the memory 417.

The controller 416 may store a data signal which is received through the second interface 412 in the memory 417 in the data section. In addition, the controller 416 may transmit a data signal or predetermined data in response to a received data signal to the image forming apparatus through the third interface 413′.

Meanwhile, the interface controller 418 may control the power extracting circuit 415 to extract power from a clock signal in the idle section.

As described above, according to an exemplary embodiment, the CRUM unit 410′ may further include the third interface 423′ to transmit a data signal and thus, may satisfy the standard of a consumable unit consisting of four terminals.

In addition, the CRUM unit 410′ further include two interfaces 412, 413′ for data communication and thus, may reduce data traffic. In some cases, the CRUM unit 410′ may use one of the second and the third interfaces 412, 413′ selectively.

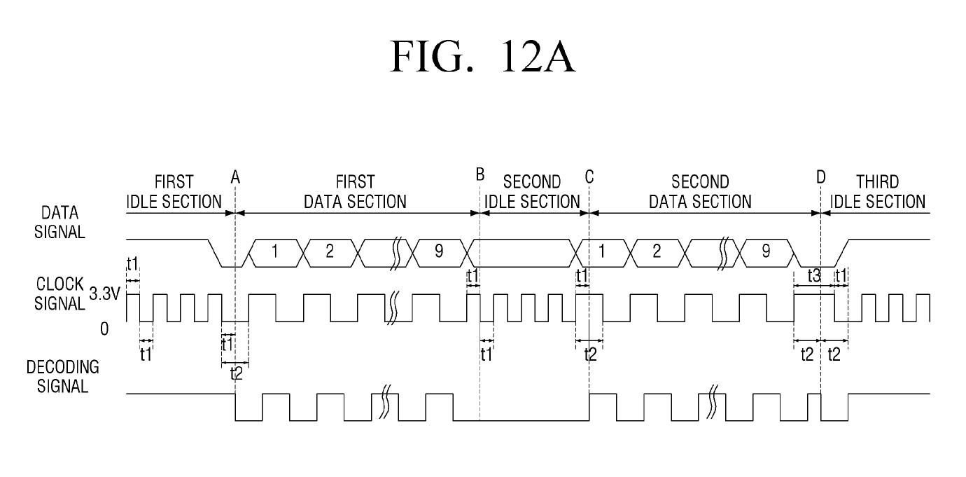

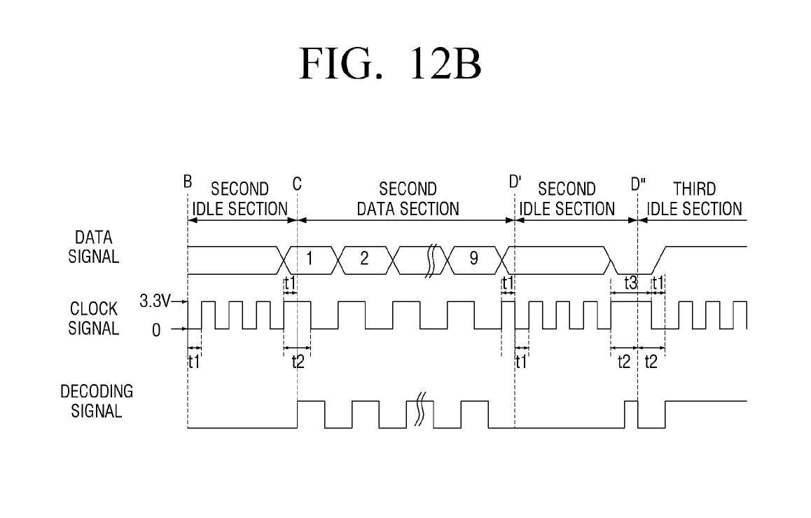

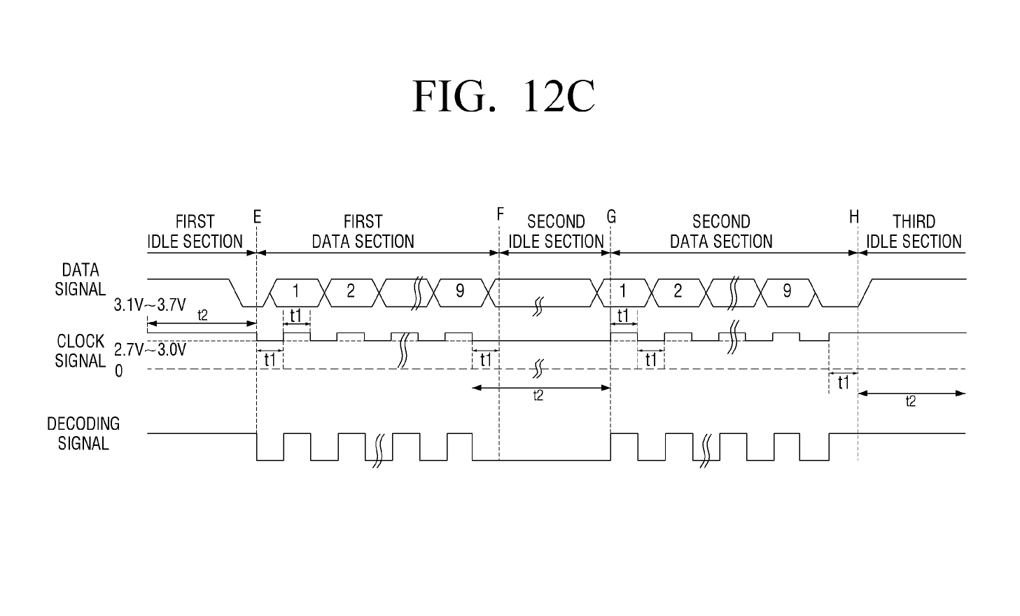

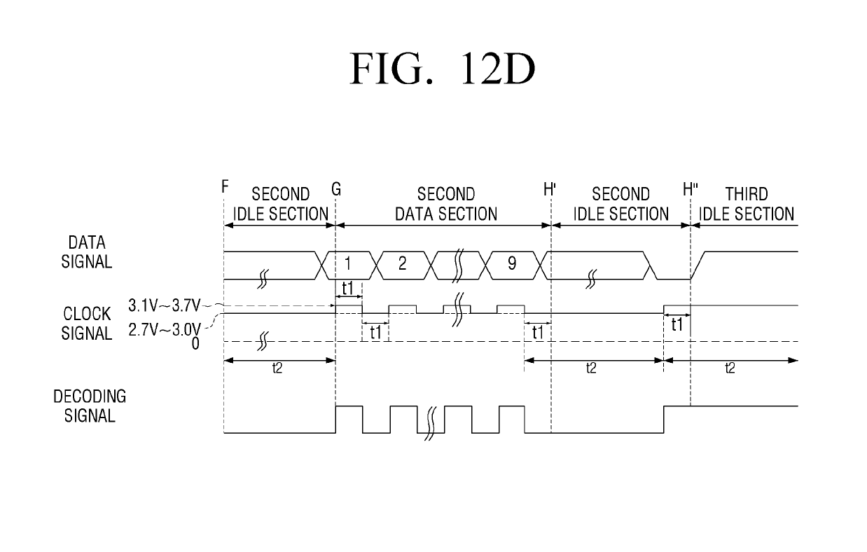

FIGS. 12A to 12D are views provided to explain various examples of a data signal, a clock signal and a wave form according to a decoding signal.

FIG. 12A is a view illustrating a data signal, a clock signal according to the first exemplary embodiment, and a wave form of a decoding signal where a clock signal is decoded.

According to FIG. 12A, a clock signal may have different clock wave forms and different pulse widths in the idle section and the data section. Specially, the clock signal may have the a first pulse width in the data section, and may have the second pulse width which is different from the first pulse width in the idle section. In this case, it is desirable that the first pulse width is greater than the second pulse width.

Meanwhile, in a first idle section, the clock signal has a wave form where a high value and a low value repeatedly alternate by the first time (t1) unit. The CRUM unit may extract power from a high value which is received during the first time in the first idle section. In this case, the low value of the clock signal may be ‘0,’ and the high value of the clock signal may be 3.3V, but not limited thereto, the low value and the high value may vary depending upon a model or specification of an image forming apparatus.

The data signal does not include substantial data in the first idle section. However, in the first idle section, the data signal may have a wave form having one of a high value and a low value. The wave form of the data signal in the first idle section may be set randomly, and may be set in the same manner in other idle sections.

Meanwhile, when a high value and a low value of a clock signal repeatedly alternate by the first time (t1) unit in the first idle section and a section where the low value of the clock signal is maintained exceeds the first time (t1), the CRUM unit may determine that the point of time when the first time (t1) exceeds is the time when reception of a data signal starts (A). Herein, the time when reception of a data signal starts (A) may be a time when start of the reception of a data signal is notified by an image forming apparatus.

At the time when reception of a data signal starts (A), the first idle section may be changed to a first data section. In this case, a clock signal has a wave form where a high value and a low value repeatedly alternate according to a second time (t2) which is set to be longer than the first time (t1).

Herein, it is desirable that the second time (t2) is two times longer than the first time (t1), but not limited thereto. The second time (t2) may be a time when power sufficient to operate the CRUM unit for a cycle is extracted from a high value of a clock signal. When the second time (t2) is shorter than the time (t), the power of the CRUM unit is used up, and thus, the CRUM unit cannot operate. Accordingly, the second time (t2) may be set to be equal to or longer than the time (t).

Meanwhile, when a high value and a low value of a clock signal repeatedly alternate in the first data section and the high value of the clock signal has the first time (t1), the CRUM unit may determine that the point of time when the high value of the clock signal has the first time (t1) is a first section change time when the first data section is changed to the second idle section (B).

In addition, when a high value and a low value of a clock signal repeatedly alternate by the second time (t2) unit in the first data section and the high value of the clock signal has the first time (t1), the CRUM unit may recognize that a data section is connected after the second idle section. Accordingly, the CRUM unit may maintain an active state of a connection state with an image forming apparatus.

In the second idle section, a clock signal has a wave form where a high value and a low value repeatedly alternate by the first time (t1) unit.

When a high value and a low value of a clock signal repeatedly alternate in the second idle section and a section where the high value of the clock signal is maintained exceeds the first time (t1), the CRUM unit may determine that the second data section starts at the point of time when the first time (t1) exceeds. Accordingly, the CRUM unit may determine that the point of time when the high value of the clock signal exceeds the first time (t1) is a second section change time (C).

In the second data section, a clock signal has a wave form where a high value and a low value repeatedly alternate by the second time (t2) unit.

In FIG. 12A, the second idle section and the second data section are included once respectively, but not limited thereto. If a large amount of data is transmitted/received, the second idle section and the second data section may be included more than two times. Alternatively, if a small amount of data is transmitted/received, the second idle section and the second data section may not be included.

Meanwhile, when a high value and a low value of a clock signal repeatedly alternate in the second data section and the time when the high value of the clock signal is maintained exceeds the second time (t2), the CRUM unit may recognize that the time when the high value of the clock signal exceeds the second time (t2) is the time when reception of a data signal ends (D). For example, if the time when the high value of the clock signal is maintained is a third time (t3), the third time (t3) have to exceed the second time (t2), and preferably, may be equal to or shorter than the first time (t1)+the second time (t2).”

At the time when reception of a data signal ends (D), a data signal transmitting/receiving operation ends and the second data section is changed to a third idle section. In the third idle section, only a clock signal may be received from an image forming apparatus.

In the third idle section, as in other idle sections, a high value and a low value of a clock signal repeatedly alternate by the first time (t1) unit.

Accordingly, the CRUM unit may determine the reception start time (A), the first section change time (B), the second section change time (C), and the reception end time (D) based on the clock signal, and perform the data signal transmitting/receiving operation and a power extracting operation.

Meanwhile, the CRUM unit may decode a data signal based on a clock signal and generate a decoding signal based on the decoding result. This decoding operation may be performed by the interface controller included in the CRUM unit.

According to FIG. 12A, when a clock signal whose high value and low value are changed by the first time (t1) unit as in the first idle section, the second idle section, and the third idle section is received, a data signal is not received. Thus, the CRUM unit generates a decoding signal to be one of “0” and “1.” When a clock signal whose high value and low value exceed the first time (t1) as in the first data section and the second data section is received, the CRUM unit may recognize that the section is a data section.

Accordingly, in the first data section and the second data section, the CRUM unit generates a decoding signal having a wave form where “0” and “1” repeatedly alternate at each point where a high value and a low value of a clock signal exceed the first time (t1).

That is, the decoding signal illustrated in FIG. 12A is maintained consistently as one of “0” and “1” in the first idle section, the second idle section, and the third idle section, and has a wave form where “0” and “1” repeatedly alternate according to the second time (t2) in the first data section and the second data section.

In FIG. 12A, a low value included in a clock signal has a value of ‘0’ in the data section and the idle section, but not limited thereto. That is, in the data section and the idle section, the low value exceeds ‘0,’ and may be smaller than 3.3V that is a high value. The decoding signal in this case may be the same as the decoding signal illustrated in FIG. 12A.

In FIG. 12A, the third idle section is not a necessary section, and may be selectively included according to a programming method of an image forming system or software thereof. If the third idle section does not exist, the CRUM unit may finish a transmitting/receiving operation for a data set at the reception end time (D). In addition, the CRUM unit may repeat the first idle section in order to start a transmitting/receiving operation for other data set.

In FIG. 12A, the third idle section is connected after the second data section, but not limited thereto. To be specific, according to software which generates a clock signal, the second idle section may be connected after the second data section. This operation is described with reference to FIG. 12B.

FIG. 12B is a modified example of the first exemplary embodiment. Although FIG. 12B does not illustrate the first idle section and the first data section, those sections are the same as the sections illustrated in FIG. 12A, and the second idle section is also the same as that illustrated in FIG. 12A.

In the second data section, a clock signal has a wave form where a high value and a low value repeatedly alternate by the second time (t2) unit. When a high value and a low value of a clock signal repeatedly alternate in the second data section and the high value of the clock signal has the first time (t1), the CRUM unit may recognize that the second idle section is connected after the second data section.

Accordingly, the CRUM unit may recognize that the point of time when the high value of the clock signal has the first time (t1) is a third section change time when the second data section is changed to the second idle section again (D′).

Meanwhile, in the second idle section which is connected to the second data section, a clock signal has a wave form where a high value and a low value repeatedly alternate by the first time (t1) unit. When the time when the high value of the clock signal is maintained exceeds the second time (t2), the CRUM unit may recognize that the point of time when the high value of the clock signal exceeds the second time (t2) is time when reception of a data signal ends (D″).

At the reception end time (D″), the CRUM unit and the image forming apparatus enter into a standby state, and a data signal receiving operation may end. If the CRUM unit and the image forming apparatus enter into the standby state, a data signal is not received from the image forming apparatus, and thus, the second idle section is changed to the third idle section.

FIG. 12C is a view illustrating a data signal, a clock signal according to the second exemplary embodiment, and a wave form of a decoding signal where a data signal is decoded.

According to FIG. 12C, in the first idle section, a clock signal has a wave form where a high value is maintained consistently. In the first idle section, a data signal does not include substantial data, and may have a wave form having one of a high value and a low value, which are the same as in other idle sections.

When a high value is maintained for the second time (t2) which is longer than the first time (t1) in the first idle section and changed to a first low value, the CRUM unit may determine that the point of time when the high value is changed to the first low value is the time when reception of a data signal starts (E). In the data signal reception start time (E), the standby state of the image forming apparatus and the CRUM unit may be changed to an active state in order to receive a data signal. Herein, a high value may be 3.1V-3.7V, and a low value may be 2.7V-3.0V to be smaller than the high value, but not limited thereto. The high value and the low value may vary depending upon a model or a specification of the image forming apparatus.

At the data signal reception start time (E), the first idle section is changed to the first data section. In the first data section, a clock signal has a wave form where a high value and a low value repeatedly alternate by the first time (t1) unit. The first time (t1) may have a predetermined time according to a protocol between the image forming apparatus and the CRUM unit, and the second time (t2) is not set, but may be longer than the first time (t1).

When a high value and a low value of a clock signal repeatedly alternate by the first time (t1) unit and the low value of the clock signal exceeds the first time (t1), the CRUM unit may recognize that the point of time when the low value exceeds the first time (t1) is a first section change time when the first data section is changed to the second idle section (F).

In the second idle section, a clock signal has a wave form where a low value is maintained consistently. When the low value is maintained consistently in the second idle section and changed to a high value, the CRUM unit may recognize that a part where the low value is changed to the high value is a second section change time (G). That is, at the second section change time (G), the second idle section may be changed to the second data section.

In FIG. 12C, the second idle section and the second data section are included once respectively, but not limited thereto. When a large amount of data is transmitted/received, the second idle section and the second data section may be included more than two times. Alternatively, when a small amount of data is transmitted/received, the second idle section and the second data section may not be included.

When a high value and a low value of a clock signal repeatedly alternate in the second data section and the high value exceeds the first time (t1), the CRUM unit may determine that a part where the high value exceeds the first time (t1) is the time when reception of a data signal ends (H).

At the data signal reception end time (H), the CRUM unit and the image forming apparatus may enter into the standby state, and a data signal receiving operation may end. When the CRUM unit and the image forming apparatus enter into the standby state, a data signal is not received from the image forming apparatus, and thus, the second data section is changed to the third idle section.

Accordingly, the CRUM unit may determine the data signal reception start time (E), the first section change time (F), the second section change time (G), and the data signal reception end time (H) based on a clock signal, and perform a data signal transmitting/receiving operation and a power extracting operation.

Meanwhile, the CRUM unit may decode a data signal based on a clock signal, and generate a decoding signal based on the decoding result.

According to FIG. 12C, a data signal is not received in the first idle section, the second idle section, and the third idle section, and thus, the CRUM unit generate a decoding signal to be one of “0” and “1.”

When a clock signal whose high value and low value have the first time (t1) as in the first data section and the second data section is received, the CRUM unit may recognize that the section is a data section.

Accordingly, in the first data section and the second data section, a high value and a low value of a clock signal repeatedly alternate according to the first time (t1), and thus, the CRUM unit generates a decoding signal having a wave form where “0” and “1” repeatedly alternate according to the first time (t1).

That is, the decoding signal illustrated in FIG. 12B has a wave form where one of “0” and “1” is maintained consistently in the first idle section, the second idle section, and the third idle section, and “0” and “1” repeatedly alternate according to the first time (t1) in the first data section and the second data section.

In FIG. 12C, a low value in the first to third idle sections is the same as a low value in the first and second data sections, but not limited thereto. That is, the low value in the first to third idle sections may be 2.7V-3.0V, and the low value in the first and second data sections may be ‘0.’ The decoding signal in this case may be the same as the decoding signal illustrated in FIG. 12B.

In FIG. 12C, the third idle section is not a necessary section, and may be selectively included according to a programming method of an image forming system or software thereof. If the third idle section does not exist, the CRUM unit may end a transmitting/receiving operation for a data set at the data signal reception end time (H). In addition, the CRUM unit may repeat the first idle section in order to start a transmitting/receiving operation for other data set.

In FIG. 12C, the third idle section is connected after the second data section, but not limited thereto. To be specific, according to software which generates a clock signal, the second idle section may be connected after the second data section. This operation is described with reference to FIG. 12D.

FIG. 12D is a modified example of the second exemplary embodiment. Although FIG. 12D does not include the first idle section and the first data section, those sections are the same as the sections illustrated in FIG. 12C, and the second idle section is the same as the section illustrated in FIG. 12C.

When a high value and a low value of a clock signal repeatedly alternate by the first time (t1) unit in the second data section and the low value of the clock signal exceeds the first time (t1), the CRUM unit may recognize that the second idle section is connected after the second data section.

Accordingly, the CRUM unit may recognize that the point of time when the high value of the clock signal exceeds the first time (t1) is a third section change time when the second data section is changed to the second idle section again (H′).

Meanwhile, in the second idle section which is connected after the second data section, a clock signal has a wave form where a low value is maintained consistently. When the low value is maintained consistently in the second idle section and changed to a high value, and the high value exceeds the first time (t1), the CRUM unit may recognize that the point of time when the high value exceeds the first time (t1) is the time when reception of a data signal ends (H″).

At the data signal reception end time (H″), the CRUM unit and the image forming apparatus enter into the standby state, and a data signal receiving operation may end. When the CRUM unit and the image forming apparatus enter into the standby state, a data signal is not received from the image forming apparatus, and thus, the second idle section is changed to the third idle section.

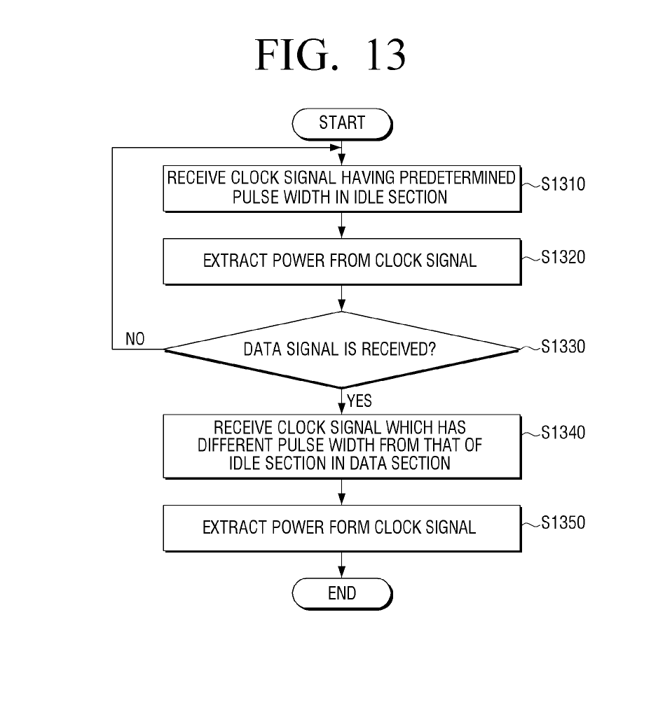

FIG. 13 is a flowchart provided to explain a power extracting method of a CRUM unit according to an exemplary embodiment. According to FIG. 13, the CRUM unit receives a clock signal having a predetermined pulse width in the idle section (S1310), and extracts power from the clock signal (S1320).

Subsequently, when a data signal is received from the image forming apparatus (S1330), the CRUM unit receives a clock signal which has a different pulse width from that of the idle section in the data section where a data signal is received (S1340). In this case, the clock signal may have the first pulse width in the data section and a second pulse width which is different from the first pulse width in the idle section. It is desirable that the first pulse width of the clock signal is greater than the second pulse width.

Meanwhile, the CRUM unit extracts power form the clock signal which is received in the data section (S1350).

The power extracting method according to FIG. 13 extracts power from a clock signal which has a different pulse width in the idle section and in the data section, respectively, and thus, the CRUM unit may be operated without any separate power supply.

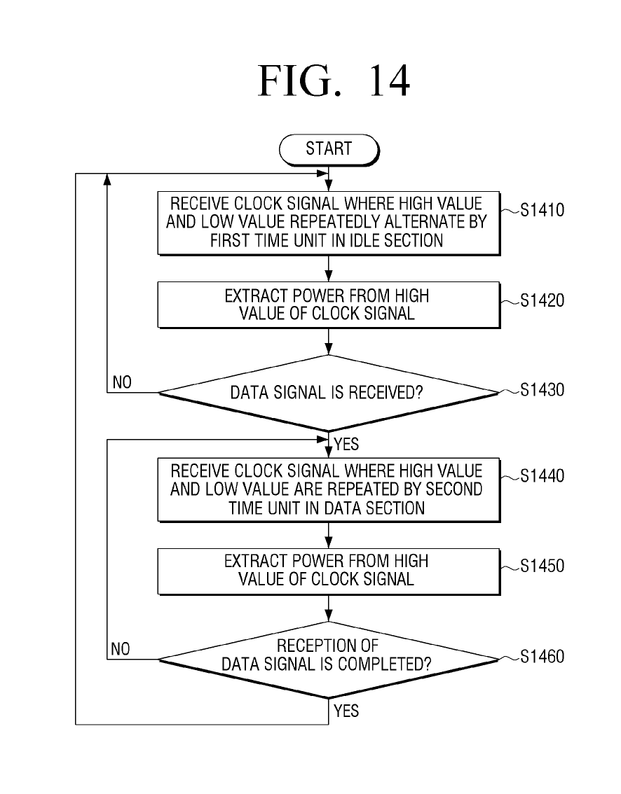

FIG. 14 is a flowchart provided to explain a power extracting method of a CRUM unit according to another exemplary embodiment. According to FIG. 14, the CRUM unit receives a clock signal where a high value and a low value repeatedly alternate by the first time unit in the idle section (S1410). Herein, the idle section may be a section where a data signal is not received from the image forming apparatus.

The CRUM unit extracts power from a high value of a clocks signal which is received in the idle section (S1420). For example, the high value of the clock signal may be 3.3V. Accordingly, while the first time where the high value of the clock signal is received, 3.3V power may be extracted and used as a driving power source of the CRUM unit.

Subsequently, when a data signal is received from the image forming apparatus (S1430), the CRUM unit receives a clock signal where a high value and a low value are repeated by the second time unit in the data section where a data signal is received (S1440). Specifically, when the data signal is received, the frequency of the clock signal may be changed in response. That is, if a high value and a low value are changed alternately by the first time unit in the idle section, the high value and the low value of the clock signal may be changed alternately by the second time unit in the data section. Herein, it is desirable that the second time is two times longer than the first time.

The CRUM unit extracts power from the high value of the clock signal which is received in the data section (S1450). Subsequently, if it is determined that the reception of the data signal is completed (S1460), the CRUM unit is changed to be in the idle section and performs the step of S1410.

On the other hand, if it is determined that the reception of the data signal is not completed (S1460), the step of S1440 is performed.

The power extracting method of FIG. 14 extracts power from the high value of the clock signal in the idle section and the data section, respectively, the CRUM unit may be operated without any separate power supply.

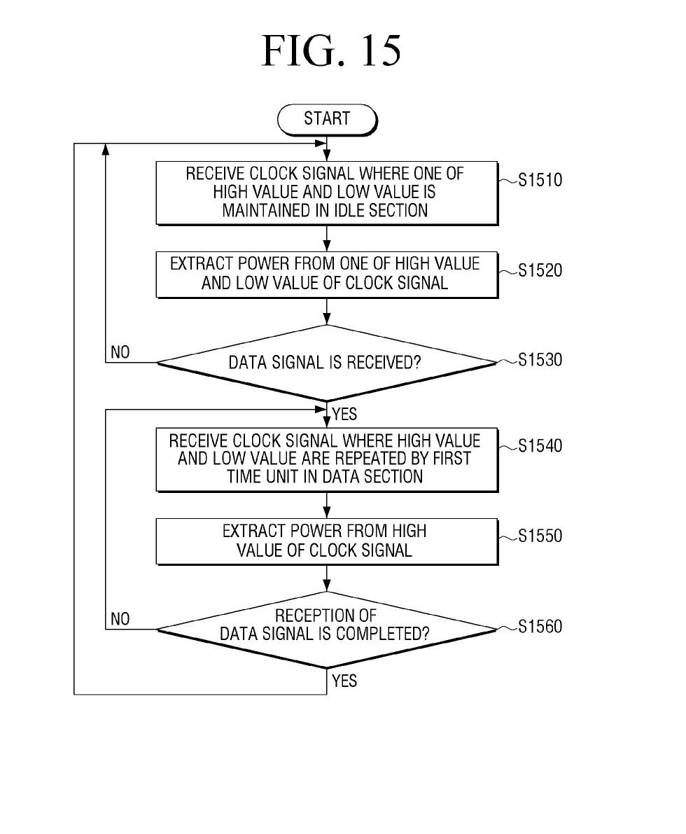

FIG. 15 is a flowchart provided to explain a power extracting method of a CRUM unit according to another exemplary embodiment.

According to FIG. 15, the CRUM unit receives a clock signal where one of a high value and a low value is maintained in the idle section (S1510).

The CRUM unit extracts power from one of the high value and the low value of the clock signal which is received in the idle section (S1520). For example, the high value of the clock signal may be 3.1-3.7V. Accordingly, if the high value of the clock signal is received in the idle section, 3.1-3.7V power may be extracted and used as a driving power source of the CRUM unit. In addition, the low value of the clock signal may be 2.7-3.0V. Accordingly, if the low value of the clock signal is received in the idle section, 2.7-3.0V power may be extracted and used as a driving power source of the CRUM unit.

Subsequently, when a data signal is received from the image forming apparatus (S1530), the CRUM unit receives a clock signal where a high value and a low value are repeated by the first time unit in the data section where a data signal is received (S1540). Specifically, when the data signal is received, the frequency of the clock signal may be changed in response. That is, if one of the high value and the low value of the clock signal is maintained longer than the first time in the idle section, the high value and the low value of the clock signal may be changed alternately by the first time unit in the data section. Herein, the first time is preset according to a protocol between the image forming apparatus and the CRUM unit. However, the second time is not set, but may be longer than the first time.

The CRUM unit extracts power from the high value of the clock signal which is received in the data section (S1550). In this case, power may be extracted not only from the high value but also from the low value.

Subsequently, if it is determined that the reception of the data signal is completed (S1560), the CRUM unit is changed to be in the idle section and performs the step of S1510.

On the other hand, if it is determined that the reception of the data signal is not completed (S1560), the step of S1540 is performed.

The power extracting method according to the above-described various exemplary embodiments may be coded as software and recorded in a non-transitory recordable medium. The non-transitory recordable medium may be installed not only in an image forming apparatus, a consumable unit, a CRUM unit but also in various types of apparatuses, and the above-described authentication method or communication method may be realized in various apparatuses accordingly.

The non-transitory recordable medium refers to a medium which may store data semi-permanently rather than storing data for a short time such as a register, a cache, and a memory and may be readable by an apparatus. Specifically, the above-described various applications and programs may be stored in the non-temporal recordable medium like CD, DVD, hard disk, Blu-ray disk, USB, memory card, ROM, etc. and provided therein.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A Customer Replacement Unit Monitor, CRUM, unit which is mountable on a consumable unit of an image forming apparatus, the CRUM unit comprising:
a plurality of interfaces configured to be connected to the consumable unit;
a power extracting circuit configured to, when a clock signal is received through one of the plurality of interfaces, extract power from the clock signal; and
an interface controller configured to transmit/receive data through at least one of the plurality of interfaces according to the clock signal,
wherein the clock signal has a first pulse width in a data section where a data signal is received and has a second pulse width which is different from the first pulse width in an idle section where a data signal is not received.

2. The CRUM unit as claimed in claim 1, wherein the interface controller, when it is determined that the idle section is changed to the data section based on the clock signal, is operable to transmit/receive the data signal in the data section.

3. The CRUM unit as claimed in claim 2, wherein the interface controller, when a high value and a low value of the clock signal repeatedly alternate in the idle section and a section where a low value of the clock signal is maintained exceeds a predetermined first time, is operable to determine that the time when the section exceeds the first time as a time when reception of the data signal starts, and
when a high value and a low value of the clock signal repeatedly alternate in the data section or the idle section and a section where a high value of the clock signal is maintained exceeds a predetermined second time, is operable to determine that the time when the section exceeds the second time as a time when reception of the data signal ends.

4. The CRUM unit as claimed in claim 2, wherein the power extracting circuit is operable to extract the power using a clock signal having the first pulse width and a clock signal having the second pulse width,
wherein the interface controller is operable to transmit/receive a decoding signal corresponding to the data section based on the clock signal.

5. The CRUM unit as claimed in claim 2, further comprising:
a memory; and
a controller configured to be activated by the power and manage the memory according the data signal which is transmitted/received to/from the interface controller.

6. The CRUM unit as claimed in claim 5, wherein the interface controller, the memory, and the controller consist of at least one Integrated Chip, IC.

7. The CRUM unit as claimed in claim 2, wherein the power extracting circuit comprises:
a diode configured to pass a clock signal having a high value out of the clock signal; and
a capacitor configured to be recharged by the clock signal which is passed from the diode.

8. The CRUM unit as claimed in claim 2, wherein the power extracting circuit comprises:
a switching element configured to be connected to the interface and pass a clock signal having the high value by performing a switching operation according to the clock signal which is received through the interface; and
a capacitor configured to be recharged by the clock signal which is passed from the switching element.

9. The CRUM unit as claimed in claim 1, wherein the plurality of interfaces comprises:
a first interface configured to receive the clock signal from a clock terminal provided on the consumable unit;
a second interface configured to transmit/receive the data signal to/from a data terminal provided on the consumable unit;
a third interface configured to be connected to a power terminal provided on the consumable unit; and
a fourth interface configured to be connected to a ground terminal provided on the consumable unit,
wherein the third interface maintains an inactive state.

10. The CRUM unit as claimed in claim 1, wherein the plurality of interfaces comprises:
a first interface configured to receive the clock signal from a clock terminal provided on the consumable unit;
a second interface configured to receive the data signal from a first data terminal provided on the consumable unit;
a third interface configured to transmit a data signal to the image forming apparatus through a second data terminal provided on the consumable unit; and
a fourth interface configured to be connected to a ground terminal provided on the consumable unit.

11. The CRUM unit as claimed in claim 1, wherein the clock signal has a clock wave form where a high value section and a low value section having the second pulse width repeatedly alternate in the idle section, and a size of the clock signal in the high value section exceeds ‘0’.

12. The CRUM unit as claimed in claim 1, wherein the clock signal has a clock wave form where a high value section and a low value section having the second pulse width repeatedly alternate in the idle section, and a size of the clock signal in the low value section is smaller than the high value.

13. An image forming apparatus, comprising:
a main body having a main controller which is configured to control an operation of the image forming apparatus;
a consumable unit configured to be mounted on the main body to operable to communicate with the main controller; and
a CRUM unit configured to be provided on the consumable unit,
wherein the main controller is configured to transmit a clock signal where a high value and a low value repeatedly alternate in a predetermined pattern in an idle section where a data signal is not received to the CRUM unit through the consumable unit,
wherein the clock signal has a first pulse width in a data section where the data signal is received and a second pulse width which is a different from the first pulse width in the idle section.

14. An apparatus as claimed in claim 13, wherein the first pulse width of the clock signal is greater than the second pulse width.

15. The apparatus as claimed in claim 14, wherein the consumable unit comprises:
a data terminal configured to transmit/receive the data signal to/from the main controller;
a clock terminal configured to receive the clock signal which is transmitted from the main controller; and
a ground terminal.

16. The apparatus as claimed in claim 15, wherein the CRUM unit comprises:
a first interface configured to transmit/receive the data signal to/from the data terminal;
a second interface configured to receive the clock signal from the clock terminal;
a power extracting circuit configured to, when the clock signal is received through the first interface, extract power from the clock signal;
an interface controller configured to transmit/receive the data signal through at least one of the plurality of interfaces according to the clock signal;
a memory; and
a controller configured to be activated by the power and manage the memory according to the data signal which is transmitted/received to/from the interface controller.

17. The apparatus as claimed in claim 16, wherein the interface controller, when it is determined that the idle section is changed to the data section based on the clock signal, transmits/receives the data signal in the data section.

18. The apparatus as claimed in claim 17, wherein the interface controller, when a high value and a low value of the clock signal repeatedly alternate in the idle section and a section where one of the high value and the low value is maintained exceeds a predetermined first time, is operable to determine that the idle section is changed to the data section, and
when a high value and a low value of the clock signal repeatedly alternate in the data section and a section where one of the high value and the low value is maintained has the first time, is operable to determine that the data section is changed to the idle section.

19. The apparatus as claimed in claim 16, wherein the consumable unit further comprises:
a power terminal,
wherein the CRUM unit further comprises a third interface which is connected to the power terminal,
wherein the third interface maintains an inactive state at all times.

20. The apparatus as claimed in claim 16, wherein the consumable unit further comprises:
an additional data terminal,
wherein the CRUM unit further comprises:
a third interface configured to transmit a data signal to the main controller through the additional data terminal.

21. A CRUM unit which is mountable on a consumable unit of an image forming apparatus, the CRUM unit comprising:
a plurality of interfaces configured to be connected to the consumable unit;
a power extracting circuit configured to, when a clock signal is received through one of the plurality of interfaces, extract power from the clock signal; and
an interface controller configured to transmit/receive a data signal through at least one of the plurality of interfaces according to the clock signal,
wherein the clock signal is a signal where a high value and a first low value repeatedly alternate in a data section where a data signal is received, and one of a high value and a second low value is maintained in an idle section where the data signal is not received,
wherein the second low value exceeds ‘0’ and less than the high value.

22. The CRUM unit as claimed in claim 21, wherein the clock signal is a signal where the high value and the first low value repeatedly alternate according to a predetermined first time in the data section, and one of the high value and the second low value is maintained for a time which is longer than the first time in the idle section.

23. The CRUM unit as claimed in claim 21, wherein the interface controller, when it is determined that the idle section is changed to the data section based on the clock signal, is operable to transmit/receive the data signal in the data section.

24. The CRUM unit as claimed in claim 23, wherein the interface controller, when a high value of the clock signal is maintained and changed to the first low value in the idle section, is operable to determine that a point of time when the high value is changed to the first low value as a point of time when reception of the data signal starts, and
when a section where the high value of the clock signal is maintained exceeds the first time in the data section or the idle section, is operable to determine the time as a point of time when reception of the data signal ends.

25. The CRUM unit as claimed in claim 23, wherein the interface controller, when one of a high value and a second low value of the clock signal is maintained longer than a first time in the idle section and the high value and the first low value have the first time, is operable to determine that the idle section is changed to the data section, and
when a high value and a first low value of the clock signal repeatedly alternate in the data section and a section where one of the high value and the second low value is maintained exceeds the first time, is operable to determine that the data section is changed to the idle section.

26. The CRUM unit as claimed in claim 1, wherein the plurality of interfaces comprises:
a first interface configured to receive the clock signal from a clock terminal provided on the consumable unit;
a second interface configured to transmit/receive the data signal to/from a data terminal provided on the consumable unit; and
a third interface configured to be connected to a ground terminal provided on the consumable unit.

27. The CRUM unit as claimed in claim 22, wherein the first low value is the same as the second low value.

28. The CRUM unit as claimed in claim 22, wherein the first low value is ‘0’.

29. A consumable unit which is mountable on an image forming apparatus, comprising:
a first contact point configured to receive a clock signal from a main body of the image forming apparatus;
a second contact point configured to transmit/receive a data signal to/from the main body of the image forming apparatus;
a third contact point configured to be connected to a ground terminal of the main body of the image forming apparatus; and
a CRUM unit configured to receive the clock signal and the data signal,
wherein the CRUM unit is operable to extract and use power from the clock signal in an idle section in which the data signal is not received,
wherein the clock signal has a first pulse width in a data section where a data signal is received and a second pulse width which is different from the first pulse width in the idle section in which data is not received.

30. A consumable unit which is mountable on an image forming apparatus, comprising:
a first contact point configured to receive a clock signal from a main body of the image forming apparatus;
a second contact point configured to transmit/receive a data signal to/from the main body of the image forming apparatus;
a third contact point configured to be connected to a ground terminal of the main body of the image forming apparatus; and
a CRUM unit configured to receive the clock signal and the data signal,
wherein the CRUM unit is operable to extract and use power from the clock signal in an idle section in which the data signal is not received,
wherein the clock signal is a signal where a high value and a low value repeatedly alternate in a data section where the data signal is received and one of the high value and the low value is maintained in the idle section,
wherein the low value exceeds ‘0’ and less than the high value.
